(19) United States
(12) Patent Application Publication
(10) Pub. No.: US 2011/0258377 A1
(43) Pub. Date: Oct. 20, 2011

(54) DISK ARRAY SYSTEM AND COMMAND PROCESSING METHOD FOR DISK ARRAY SYSTEM

(75) Inventors: Shoji Sugino, Odawara (JP); Kiichiro Urabe, Isehara (JP); Hiroshi Taninaka, Odawara (JP); Ikuo Uratani, Kaisei (JP)

(73) Assignee: HITACHI, LTD., Tokyo (JP)

(21) Appl. No.: 12/666,924

(22) PCT Filed: Dec. 7, 2009
(86) PCT No.: PCT/JP2009/006655

§ 371 Date: Dec. 28, 2009

(51) Int. Cl. G06F 12/00

(52) U.S. Cl. 711/114; 711/E12.001

(57) ABSTRACT

Commands can be issued by being flexibly adjusted to each of an in-band method and an out-of-band method.

A disk controller includes: a pseudo-logical volume provided independently from a substantial logical volume; a command analyzer for analyzing a command received by means of communication on the in-band method or the out-of-band method; and a special command processing unit for executing operation over the substantial logical volume which corresponds to the pseudo-logical volume, instead of executing operation over the pseudo-logical volume, if the command means an instruction to operate the pseudo-logical volume.

### TECHNICAL FIELD

The present invention relates to a disk array system that performs communication on an in-band method and an out-of-band method. In particular, the present invention is suited for use in a disk array system and its command processing method relating to the technique of communication between a host server and a disk array apparatus.

### Background Art

As a result of the development of the information industry in recent years, disk array systems are used in various data processing systems. A prior disk array system includes a host server as a host system, and a disk array apparatus. This disk array apparatus is equipped with a disk controller and a service processor.

In a prior disk array system, communication on the in-band method is performed via a SCSI (Small Computer System Interface) interface between a host server and a disk controller. Also, in the prior disk array system, communication on the out-of-band method is performed via a network interface between a service processor on a disk array apparatus and a host server.

With the prior disk array system, a management application provided in the host server issues a command suited for the communication on the out-of-band method to the disk array apparatus, and operates the configuration of the disk array apparatus in response to the command (see Patent Literature 1).

### Citation List

Patent Literature

[PTL 1]

Japanese Patent Laid-Open Application Publication No. 2002-268825

### SUMMARY OF INVENTION

### Technical Problem

However, even if a command to operate the configuration of the disk array apparatus is to be sent on the in-band method in the prior disk array system, the command needs to be adjusted to the out-of-band method. Therefore, the prior disk array system has a problem of incapability of flexible adjustment relating to the issuance of commands.

The present invention was devised in light of the circumstances described, and it is an object of the present invention to suggest a disk array system and its command processing method capable of issuing commands by being flexibly adjusted to both the in-band method and the out-of-band method.

### Solution to Problem

In order to solve the above-described problem, a disk array system including a host system and a disk array apparatus for providing the host system with a substantial logical volume for reading and writing data according to this invention is characterized in that the disk array apparatus includes: a disk controller for communicating data with the host system on an in-band method; and a service processor for managing the configuration of the disk controller based on a command issued by a management application and received via communication on an out-of-band method; wherein the disk controller includes: a pseudo-logical volume provided independently from the substantial logical volume; a command analyzer for analyzing the command received via communication on the in-band method or the out-of-band method; and a special command processing unit for executing operation over the substantial logical volume which corresponds to the pseudo-logical volume, instead of executing operation over the pseudo-logical volume, if the command means an instruction to operate the pseudo-logical volume.

Also, a command processing method for a disk array system including a host system and a disk array apparatus for providing the host system with a substantial logical volume for reading and writing data according to this invention is characterized in that the disk array apparatus includes: a disk controller for communicating data with the host system on an in-band method; and a service processor for managing the configuration of the disk controller based on a command issued by a management application and received via communication on an out-of-band method; and wherein the command processing method comprising: a command analysis step for analyzing a command received via communication on the in-band method or the out-of-band method, executed by a command analyzer of the disk controller; and a special command processing step for executing operation over the substantial logical volume which corresponds to the pseudo-logical volume, instead of executing operation over the pseudo-logical volume, executed by a special command processing unit of the disk controller, if the command is analyzed to be an instruction to operate the pseudo-logical volume in the command analysis step.

### Advantageous Effects of Invention

According to the present invention, it is possible to issue commands by being flexibly adjusted to both the in-band method and the out-of-band method.

### BRIEF DESCRIPTION OF DRAWINGS

FIG. 1 is a block diagram showing the general configuration of a disk array system according to the first embodiment.

FIG. 2 is a block diagram showing an example of the configuration of a disk array apparatus and host servers.

FIG. 3 is a diagram showing an example of the configuration of logical volumes.

FIG. 4 is a diagram for explaining the concept of a command device.

FIG. 5 is a diagram for explaining how to designate a logical volume.

FIG. 6 is a diagram showing an example of a command format.

FIG. 7 is a flowchart illustrating a processing sequence executed by an open command processing unit.

FIG. 8 is a flowchart illustrating a processing sequence for processing by an UDP control unit.

FIG. 9 is a flowchart illustrating a processing sequence for special command processing.

FIG. 10 is a sequence chart illustrating a processing sequence of a management application.

FIG. 11 is a flowchart illustrating a processing sequence for displaying a management screen.

FIG. 12 is a block diagram showing an example of the configuration of a disk array apparatus and host servers according to a variation.

FIG. 13 is a block diagram of user authentication according to the second embodiment.

FIG. 14 is a flowchart illustrating an example of processing sequence for user authentication processing.

FIG. 15 is a block diagram of user authentication according to a variation.

### REFERENCE SIGNS LIST

3 Host server
3A First management application
4 Disk array apparatus
6 Definition file
41 Disk unit
42C Open command processing unit
42D UDP control unit
42E Special command processing unit
42F Session control table
43 Service processor
43A Second management application

### DESCRIPTION OF EMBODIMENTS

An embodiment of the present invention will be explained below with reference to the attached drawings.

(1) Configuration of Disk Array System according to First Embodiment

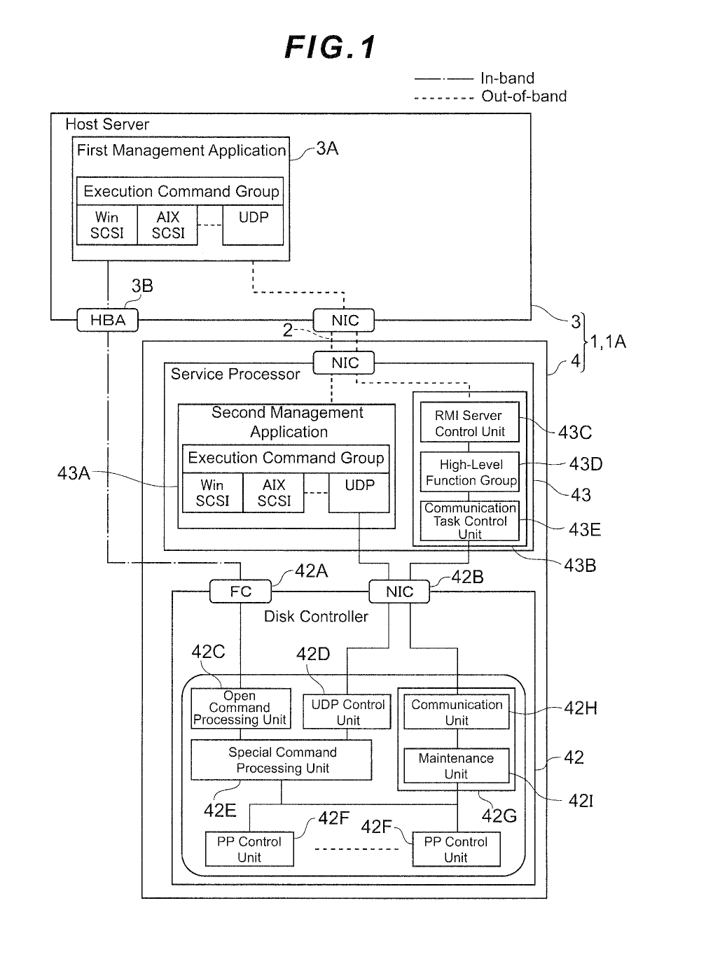

FIG. 1 shows the general configuration of a disk array system 1 according to the first embodiment. The disk array system 1 includes a host server 3 and a disk array apparatus 4.

The host server 3 and the disk array apparatus 4 are connected to each other via, for example, a SCSI (Small Computer System Interface) interface (for instance, corresponding to HBA in FIG. 1). The host server 3 communicates with the disk array apparatus 4 on a so-called in-band method using the SCSI interface.

Also, the host server 3 and the disk array apparatus 4 are connected to each other via, for example, a network interface (for example, an NIC in FIG. 1). The host server 3 communicates with the disk array apparatus 4 on a so-called out-of-band method using the network interface. Communication between the host server 3 and the disk array apparatus 4 on this out-of-band method uses, for example, UDP (User Datagram Protocol) as a protocol. With this protocol it is possible to simplify control and suppress processing load.

The host server 3 is equipped with a processor, a memory, a cache, a hard disk drive, an interface, and various interface cards. The host server 3 realizes various functions by having the processor execute programs on the memory. The host server 3 has a specified application (not shown in the drawing) and a first management application 3A as the programs. The host server 3 has a function writing data handled by the application (hereinafter referred to as the “data”) to the disk array apparatus 4 by means of communication on the in-band method and also has a function reading the data from the disk array apparatus 4.

The first management application 3A issues a command included in command in an execution command group, including a SCSI command and a UDP command as a command. In the present embodiment, the first management application 3A communicates a command issued as described later either on the in-band method via, for example, a SCSI interface or the out-of-band method via a network interface.

The disk array apparatus 4 has a disk controller 42 and a service processor 43 as a service processor. The service processor 43 is connected to the host server 3 via the above-mentioned network interface (which is NIC in FIG. 1). On the other hand, the disk controller 42 is connected to the host server 3 via, for example, a SCSI interface (which is FC in FIG. 1). Also, the disk controller 42 is connected to the service processor 43 via, for example, a network interface (which is NIC 42B in FIG. 1).

The service processor 43 has a second management application 43A and may also have a microprogram 43B. The second management application 43A is a microprogram that receives a command issued by the above-described first management application 3A and executes specified processing. The second management application 43A receives the command issued by the first management application 3A and delivers it to an UDP control unit 42D described later. The microprogram 43B is a module for realizing a management function and its details will be described later.

The disk controller 42 includes an open command processing unit 42C, an UDP control unit 42D, a special command processing unit 42E, a PP control unit 42F, and a microprogram 42F. The microprogram 42F is a module for a management function and its details will be described later. The open command processing unit 42C and the UDP control unit 42D correspond to a command processing unit. This command processing unit analyzes a command received via communication on the in-band method or the out-of-band method.

The open command processing unit 42C analyzes a command such as a SCSI command received via communication on the in-band method and judges whether the command is a special command or not. On the other hand, the UDP control unit 42D analyzes a command such as an UDP command received via communication on the out-of-band method and judges whether the command is a special command or not.

If it is determined based on the result of analysis by the open command processing unit 42C or the UDP control unit 42D that the command is a special command, the special command processing unit 42E executes special command processing described later. This special command processing will be explained later. The PP control unit 42F controls operation of logical volumes.

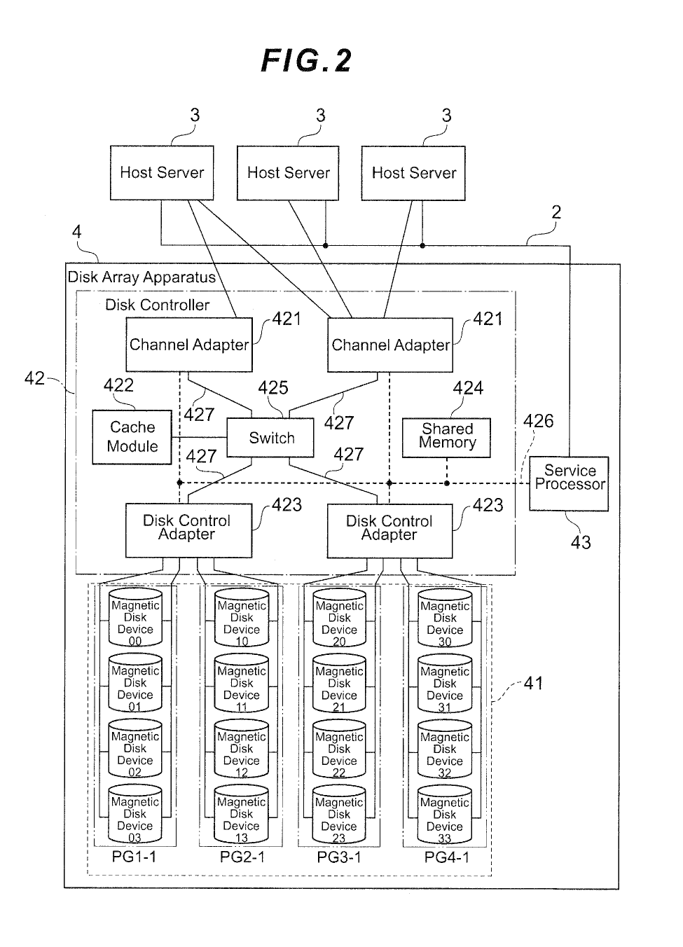

FIG. 2 shows an example of the configuration of the disk array system 1. A specified application (not shown in the drawing) and the first management application 3A operate in the host server 3. The host server 3 writes/reads data, which are handled by the application (hereinafter referred to as the data), from and to the disk array apparatus 4. The disk array apparatus 4, for example, stores the data in accordance with a write command received from the host server 3 and reads the stored data in accordance with a read command and sends it to the host server 3.

The network 2 is, for example, a LAN (Local Area Network), the Internet, a SAN (Storage Area Network), or public lines. The network 2 includes a network switches and hubs. The host server 3 communicates with the disk array apparatus 4 via the network 2, using a protocol such as TCP/IP (Transmission Control Protocol/Internet Protocol).

The host server 3 is a general purpose computer, but it may be a workstation or a mainframe computer. The host server 3 is equipped with the first management application 3A and a user application (not shown in the drawing). On a side note, the first management application 3A may be provided not only in the host server 3 as described above, but also in other devices. The user application has a specified data processing function so that it reads/writes the data from/to the disk controller 42.

The first management application 3A is software for managing configuration information about the disk controller 42. The first management application 3A issues a command to the disk controller 42. The first management application 3A issues, for example, the following command to obtain port information about three logical volumes (such as LDEV 00):
raidcfg -a qry -o port -u 1

The host server 3 is equipped with a processor, a main memory, a communication interface, and a local input-output device as hardware resources, which are connected to each other via an internal bus. The host server 3 has, as software resources, an operating system and device drivers as well as the first management application 3A and the user application described earlier.

The disk array apparatus 4 includes a disk unit 41, a disk controller 42, and a service processor 43. The disk controller 42 controls access such as writing/reading data from and to the disk unit 41. The service processor 43 is connected to the disk controller 42 and manages the entire disk array apparatus 4.

The disk unit 41 includes one or more storage media such as magnetic disk devices, and the magnetic disk devices constitute RAID (Redundant Arrays of Inexpensive Disks). A storage area group provided by the disk unit 41 is defined as one or more logical volumes. The logical volumes can be classified by attributes in accordance with the intended use. The disk unit 41 introduces management units of groups PG1-1 to PG4-1 in order to manage the update order within a logical volume and between logical volumes.

An identifier LUN (Logical Unit Number) is assigned to each logical volume. A logical volume is divided into segments which are minimum access units and a logical block address (LBA) is assigned to each segment. Accordingly, the host server 3 can access data stored in a specified storage area in a logical volume by giving the logical address, which is constituted from the identifier LUN and the logical block address, to the disk controller 42 for the disk array apparatus 4. The above-described information about the logical volumes is stored as part of system configuration information in the disk controller 42.

The above-mentioned disk controller 42 is equipped with a plurality of channel adapters (CHA) 421, a cache module 422, a plurality of disk control adapters (DKA) 423, and a shared memory (SM) 424. The plurality of channel adapters 421, the cache module 422, and the plurality of disk control adapters 423 are connected to a switch 425 (CSW) via a data line 427 and can exchange data through the data line 427 and the switch 425. On aside note, as a general rule, the data line is indicated by a solid line and a control line is indicated by a broken line. On the other hand, the plurality of channel adapter 421, the cache module 422, the plurality of disk control adapters 423, and the shared memory 424 are connected to each other via a control line 426 connected to the service processor 43.

The channel adapter 421 functions as a communication interface that sends/receives commands and data relating to I/O access from and to the computer 3 connected via the network 2. The channel adapter 421 is connected to the service processor 43 via the control line 426 as described above and performs specified communication with the service processor 43.

The cache module 422 is a storage medium that temporarily stores data exchanged between the host server 3 and the disk unit 41. Specifically speaking, the cache module 422 is used as a temporary storage medium for sending and receiving data between the channel adapter 421 and the disk control adapter 423.

The disk control adapter 423 functions as an input-output interface for controlling access to the disk unit 41. The disk control adapter 423 is connected to the service processor 43 via the control line 426 as described above and performs specified communication with the service processor 43.

The shared memory 424 is a storage medium for storing, for example, system configuration information and operating information about the disk array apparatus 4. The system configuration information is information about the system configuration of the disk array apparatus 4. On the other hand, the operating information is information about the operating state of the disk array apparatus 4, which is collected from each module while the disk array apparatus 4 operates. The shared memory 424 is connected to the service processor 43 via the control line 426 as described above and is a storage medium for storing information shared in the disk array apparatus 4. The service processor 43 can refer to the information in the shared memory 424 via the control line 426.

The switch 425 is a switch circuit including a crossbar switch. The switch 425 mediates settlement for conflicts of data signals input via the data line 427, switches data signal paths, and constructs a path between a transmission source module and a transmission destination module.

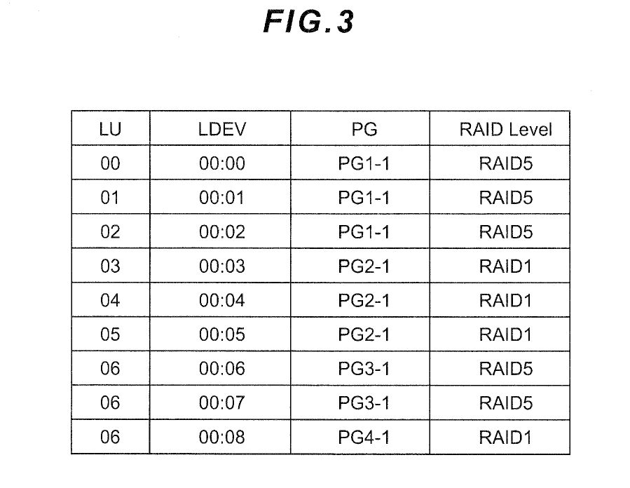

FIG. 3 shows information such as the logical unit number of the magnetic disk devices provided in the disk unit 41. On a side note. LU in FIG. 3 represents the logical unit number, LDEV represents the LDEV number (logical device number). PG represents the aforementioned group, and a RAID level indicates the RAID type. For example, FIG. 3 shows that the LDEV number corresponding to the logical unit number 00 is 00:00, its group PG is PG1-1, and the RAID level is RAID 5. On aside note, the group PG PG1-1 is a group of magnetic disk devices arranged in the leftmost vertical line in FIG. 2 described earlier.

(2) Concept of Command Device

(2-1) Outline

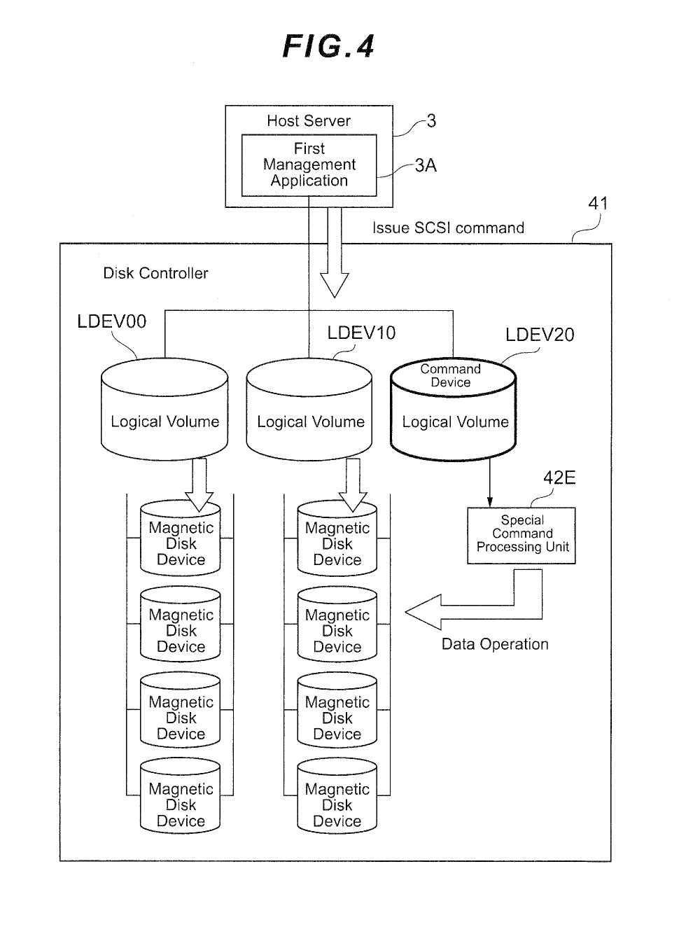

FIG. 4 shows the concept of a command device. The command device is a dummy logical volume which is unsubstantial, but the LDEV number is assigned to it This dummy logical volume is also called a pseudo-logical volume. The LDEV number is assigned to a pseudo-logical volume and the host server 3 can refer to the logical volume corresponding to that LDEV number.

The disk controller 42 has not only first and second logical volumes LDEV 00, LDEV 10 as substantial logical volumes, but also a pseudo-logical volume LDEV 20 as a pseudo-logical volume. The LDEV numbers LUN 00 and LUN 01 are assigned to the first and second logical volumes LDEV 00, LDEV 10. On the other hand, the LDEV number LUN 02 is assigned to the pseudo-logical volume LDEV 20.

The host server 3 issues a SCSI command by designating the LUN (Logical Unit Number). After the logical volume LDEV 20 serving as a command device receives the SCSI command, the command type of the SCSI command is analyzed and whether the command type is “write” or not is checked. If the command type is “write,” special command processing described later is executed instead of executing the operation to write data to the logical volume LDEV 20.

(2-2) How to Designate Destination of Command (Logical Volume)

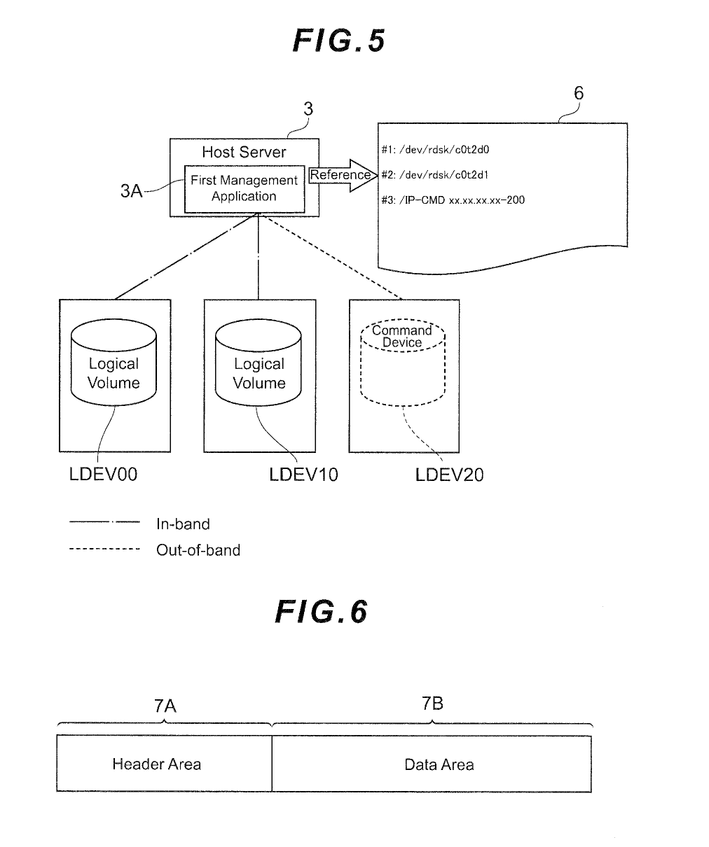

FIG. 5 shows an example of how to designate a logical volume. The first management application 3A can issue the same command regardless of the communication type, whether the in-band method or the out-of-band method, and decides a logical volume which is the destination of the command, as follows.

The first management application 3A refers to a definition file 6 retained by, for example, the service processor 43 and then designates the destination to which the command is directed as described below, depending on which communication method is selected, the in-band method or the out-of-band method. This definition file 6 defines not only two paths (first and second paths #1, #2) for the first and second logical volumes LDEV 00, LDEV 10, but also a path (third path #3) for the pseudo-logical volume LDEV 20.

The first path #1 represents a directory used when accessing the first logical volume LDEV 00, and the second path #2 represents a directory used when accessing the second logical volume LDEV 10 which is the substantial logical volume. On the other hand, the third path #3 represents an IP address used when accessing the pseudo-logical volume LDEV 20. This definition file 6 defines the first path #1, the second path #2, and the third path #3, for example, as shown below in the order beginning at the top.

#1: /dev/rdsk/c0t2d0

#2: /dev/rdsk/c0t2d0

#3: /IP-CMD-xx.xx.xx.xx-200

If the first management application 3A issues a command using communication on the in-band method, it designates the first path #1 or the second path #2 as the destination of header information in the format of the command. On the other hand, if the first management application 3A issues a command using communication on the out-of-band method, it designates the third path #3 as the destination of header information in the format of the command.

FIG. 6 shows an example of the format of a command issued by the first management application 3A. The command has a header area 7A and a data area 7B. The header area 7A contains header information including the logical unit number (LU#) and port number indicating the destination of the command, as well as the command type such as Write, Read, or Inquiry. The data area 7B contains the operation content to be performed on the logical volume such as a path definition linking the LDEV number with the logical unit number (LU#), copy, pair definition, and LU definition.

In the present embodiment, the command type and the data area 7B are utilized actively from among the items mentioned above. Specifically speaking, if the logical unit number is “LUN 02” and the command type is, for example, “write,” that is, the command means writing data to the pseudo-logical volume LDEV 20 which is unsubstantial, the special command processing unit 42E judges that the special command processing should be executed instead of actually executing the operation to write data to the pseudo-logical volume LDEV 20. During the special command processing, the special command processing unit 42E executes the operation on the PP control unit 42F in accordance with the operation content stored in the data area 7B and operates either one of the substantial logical volumes LDEV 00, LDEV 10 associated with the pseudo-logical volume LDEV 20.

The special command processing unit 42E can have the PP control unit 42F perform PP control regardless of whether the command is received via communication on the in-band method or communication on the out-of-band method, that is, regardless of the difference in communication methods.

(3) Examples of Actions of Disk Array System According to First Embodiment

As the disk array system has the configuration as described above, it operates as described below.

(3-1) Processing on In-band Method

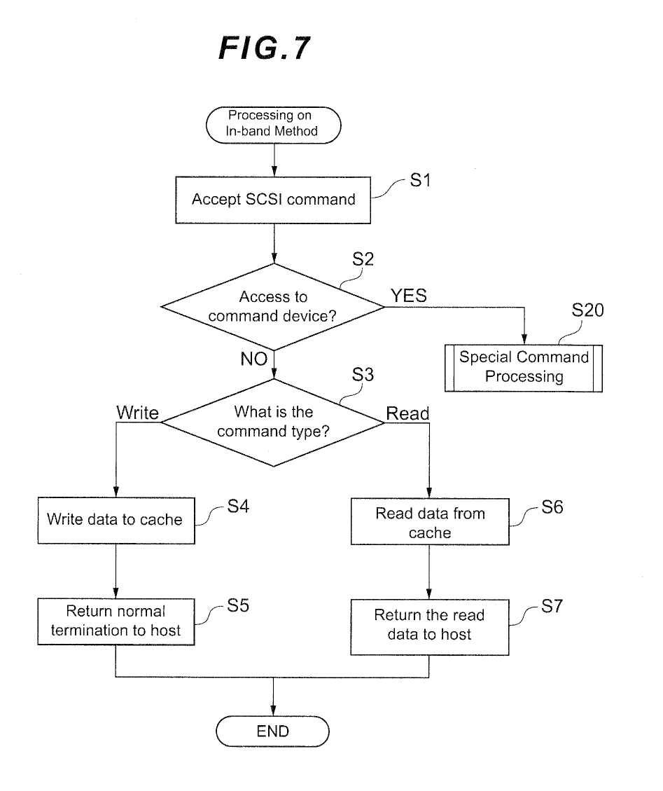

FIG. 7 shows the content of processing executed when the open command processing unit 42C receives a SCSI command as an example of a command. After the open command processing unit 42C accepts the SCSI command via communication on the in-band method (step S1), it analyzes this SCSI command and judges whether it is access to the command device (which corresponds to the pseudo-logical volume LDEV 20) or not (step S2).

In other words, the open command processing unit 42C analyzes the header area 71 of the SCSI command and checks if the destination contained in the header information is the command device or not. Specifically speaking, the open command processing unit 42C checks if the LDEV number of the destination is LUN 02 (the pseudo-logical volume LDEV 20) or not. If the open command processing unit 420 determines that it is access to the command device, it delivers the SCSI command to the special command processing unit 42E and the special command processing is then executed (step S20).

On the other hand, if the open command processing unit 42C determines that it is not access to the command device, it checks the command type of the SCSI command and judges whether it is a read command or a write command (step S3). If the SCSI command is a write command, the open command processing unit 42C writes the data to a cache (not shown in the drawing) (step S4) and then returns a message of normal termination to the host server 3 (step S5).

On the other hand, if the SCSI command is a read command, the open command processing unit 42C reads the data from the cache (step S7) and returns the read data to the host server 3.

(3-2) Processing on Out-of-band Method

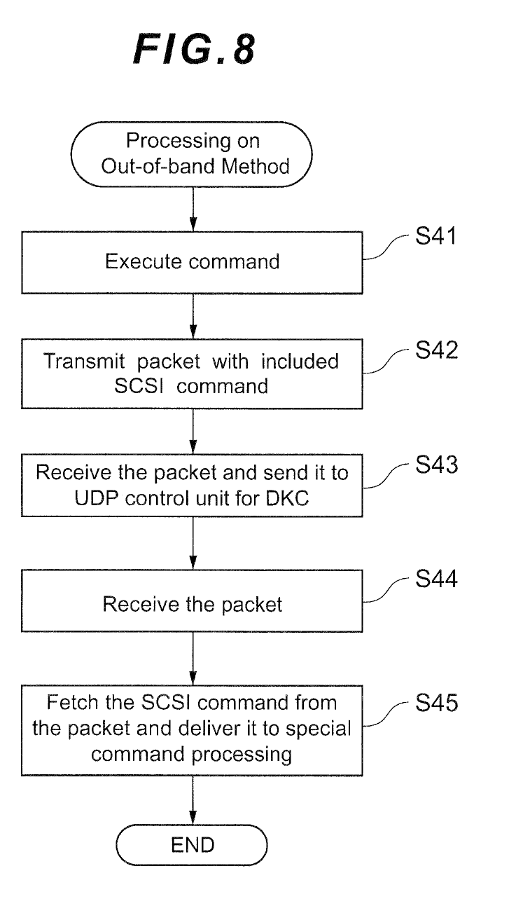

FIG. 8 shows the content of processing on the command device. After the first management application 3A executes a certain command (step S41), it first puts the SCSI command in an IP packet and performs packet transmission (step S42). Specifically speaking, the first management application 3A encapsulates this SCSI command in, for example, an UDP packet transmission frame so that the command architecture cannot be distinguished. So, an UDP header is added to the SCSI command, which will be treated as an UDP packet.

The second management application 43A operates in the service processor 43, and this second management application 43A receives the UDP packet via the network interface 42B and then simply sends it to the UDP control unit 42D for the disk controller 42 (step S43). The UDP control unit 42D receives the UDP packet (step S44). On aside note, in these steps S44 and S45, the second management application 43A and the UDP control unit 42D do not refer to the content of the UDP packet at all, and they simply deliver the UDP packet. Next, the UDP control unit 42D fetches the SCSI command from the UDP packet and delivers it to the special command processing unit 42E (command device) (step S45).

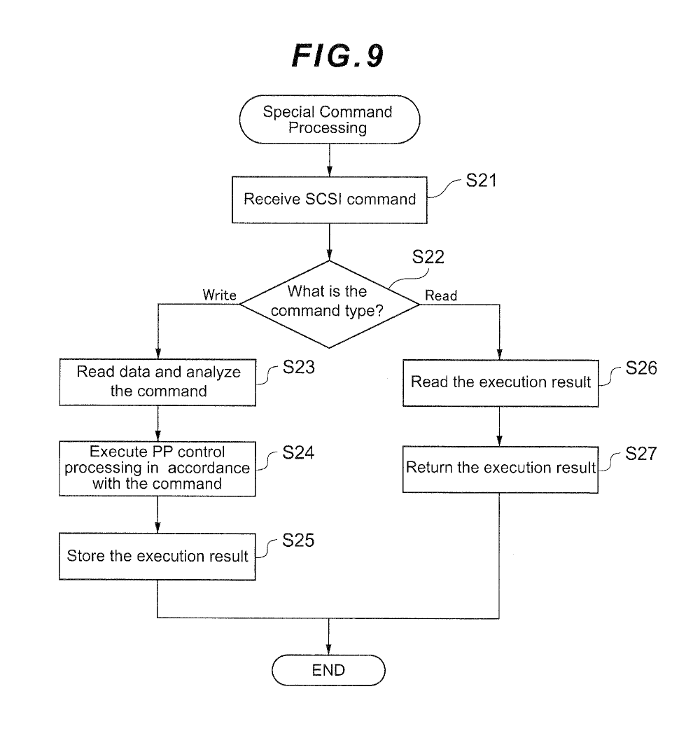

FIG. 9 shows an example of a processing sequence for the special command processing. The special command processing represents a processing sequence executed by the special command processing unit 42E. After the special command processing unit 42E receives the SCSI command (step S21), it checks the command type of the SCSI command (step S22).

If the command type is a write command, the special command processing unit 42E reads the data and analyzes the command (step S23). The special command processing unit 42E executes PP control processing according to the analyzed command (step S24) and stores the execution result in the cache (not shown in the drawing).

If the command type is a read command, the special command processing unit 42E reads the execution result stored in the cache (step S26) and returns the read execution result to the host server 3 (step S27).

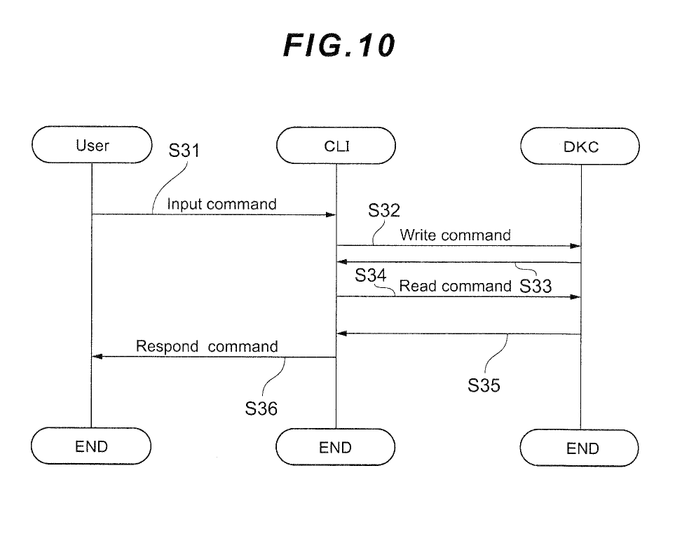

FIG. 10 shows an example of a processing sequence for processing executed by, for example, the management application (which corresponds to a CLI in the drawing) 3A. This sequence shows the passage of time as it goes downwards. On a side note, the CLI in the drawing mainly represents the first management application 3A. On a side note, a CLI (Command Line Interface) command used in the explanation below means a command for managing, for example, configuration information about the disk controller 42. If the first management application 3A is to execute one instruction, it will execute both write and read actions as described below.

If a user who is an administrator inputs a CLI command using the first management application 3A (step S31), the first management application 3A issues a write command to the disk controller 42 (step S32). After receiving the write command, the disk controller 42 operates to write the data; and when it completes the write operation, it returns a message of write completion to the first management application 3A (step S33).

The first management application 3A also issues a read command to the disk controller 42 (step S34). After receiving the read command, the disk controller 42 operates to read the data; and when it completes the read operation, it sends a message of read completion to the first management application 3A (step S35). Subsequently, the first management application 3A returns a response to the command to the user such as the administrator (step S36).

Examples of the above-described CLI command include the following:
copy pair creation: paircreate
copy state reference: pairdisplay
LDEV state reference: raidcfg -a qry-o ldev
LDEV creation: raidcfg -a reg -o ldev
On a side note, ldev corresponds to the LDEV number.

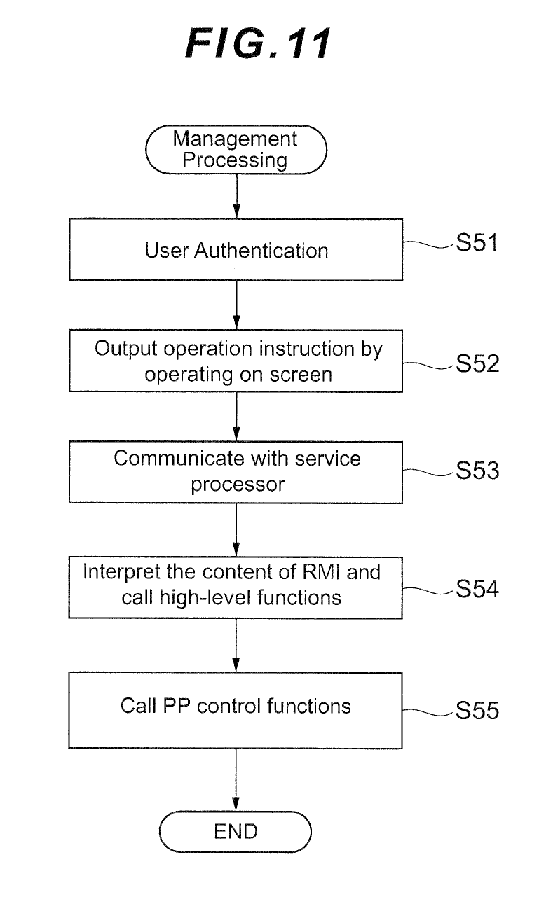

FIG. 11 is a flowchart illustrating the operation of a management screen. In step S51, the first management application 3A issues a user authentication command to the service processor 43 and has it execute user authentication processing described later. Subsequently, the first management application 3A outputs an operation instruction as operated by the user such as the administrator to the second management application 43A for the service processor 43 (step S52). Next, the second management application 43A has the RMI server control unit 43C communicate with the service processor 43, using RMI (Remote Method Invocation) (step S53). Next, a high-level function group 43D interprets the content of the RMI and calls high-level functions (step S54). Then, the high-level function group 43D has a communication task control unit 43E call, via a communication unit 42H and a maintenance unit 421 for the disk controller 42, functions to have the PP control unit 42F perform PP control (step S55).

(4) Variation

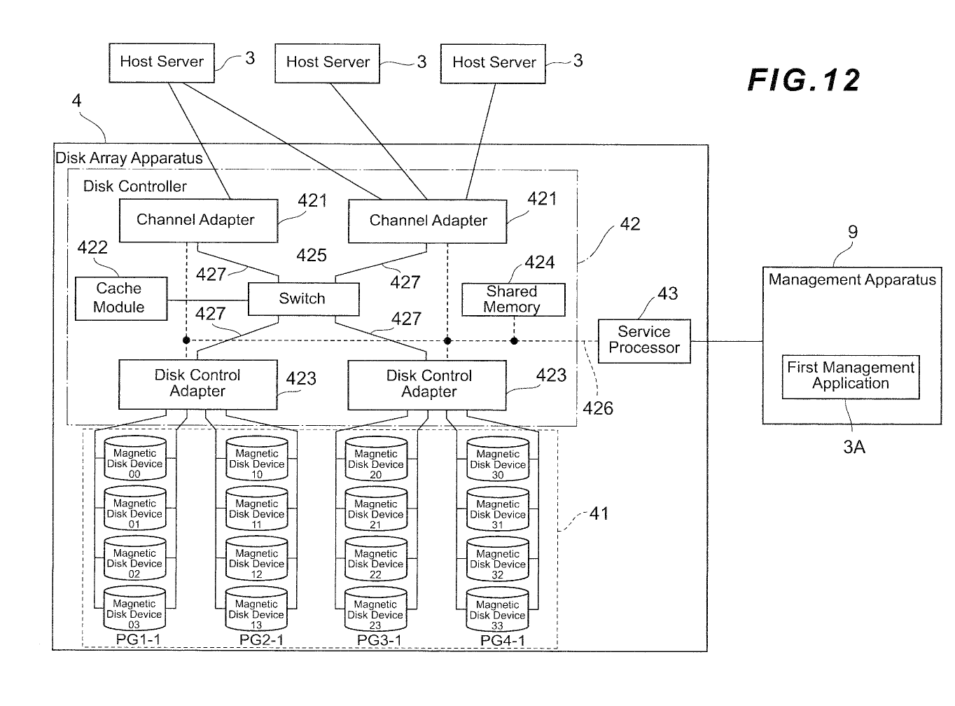

FIG. 12 shows an example of the configuration of a disk array system according to a variation of the first embodiment. The disk array system according to the variation is configured so that a management apparatus 9 in which the first management application 3A is provided and serves as a service processor is connected to the service processor 43 for the disk controller 42 is used, instead of having the first management application 3A provided in the host server 3. On a side note, since other elements of the configuration of the disk array system according to the variation are the same as the configuration of the disk array system 1 according to the mentioned first embodiment, an explanation thereof has been omitted.

(5) Effects of the First Embodiment

As explained above, in the disk array system 1 according to the first embodiment, the disk controller 42 is equipped with the pseudo-logical volume LDEV 20, the command analyzer, and the special command processing unit 42E. The command processing unit, mentioned herein, corresponds to the open command processing unit 42C and the UDP control unit 42D described later. The command processing unit analyzes a command received via communication on the in-band method or the out-of-band method. If the command means an instruction to operate the pseudo-logical volume LDEV 20 as the command device, the special command processing unit 42E executes operation over the substantial logical volume LDEV 00, LDEV 10 corresponding to the pseudo-logical volume LDEV 20 instead of executing operation over the pseudo-logical volume LDEV 20.

With this arrangement, the management application 3A can issue a command being flexibly suitable for either the in-band method or the out-of-band method. Because the communication on the out-of-band method gives less influence over the communication on the in-band method, the management application 3A does not influence to either data writing or reading via the communication on the in-band method between the host server 3 and the disk array apparatus 4. As a result, it is possible not only to read and write such data by sufficiently using the communication band on the in-band method, but also in some usage, the management application 3A issues a command to operate the configuration of the disk array apparatus 4, and can send the command using the same communication band on the same in-band method.

Usability of the disk array system 1, which has availability of both the in-band method and the out-of-band method as described above, will be explained below. Firstly, each advantage when used communication on the in-band method and the out-of-band method will be explained. The communication on the in-band method has the advantage of capability of executing processing by using the communication on the in-band method in cooperation with other applications operating on the host server 3, because of capability of being controlled by the host server 3 without the intervention of the service processor 43.

On the other hand, the communication on the out-of-band method has the advantage of capability of issuing a command without entirely using the communication band on the in-band method between the host server 3 and the disk array apparatus 4. In the disk array system 1, it is possible for the advantages of both the methods to be coexisted by appropriately and flexibly using each of the different methods.

Also, since the communication on the in-band method and the out-of-band method can be utilized flexibly in the disk array system 1, it is possible to be independently worked by, for example, an administrator, who manages data writing and reading between the host server 3 and the disk array apparatus 4, and an administrator, who manages the configuration of the disk array apparatus 4.

The disk array system 1 comprises, as the mentioned command analyzer, the open command processing unit 42C as the first command analysis processing unit for analyzing a command received via the communication on the in-band method, and the UDP control unit 42D as a second command analysis processing unit for analyzing a command received via the communication on the out-of-band method.

With this arrangement, the open command processing unit 42C and the UDP control unit 42D can independently process commands via the communication on the in-band method and the out-of-band method. It is possible that load by a processing does not influence the other processing.

Also, with the disk array system 1, a special command, as the instruction to operate the pseudo-logical volume LDEV 20, includes the header area 7A and the data area 7B. The header area 7A is an area containing the logical unit number, which indicates the pseudo-logical volume LDEV 20, and the specific command type. On the other hand, the data area 7B is an area containing the operation content to be performed on the substantial logical volume LDEV 00, LDEV 10. If the logical unit number indicates the pseudo-logical volume LDEV 20 and the header area 7A contains the specific command type, the special command processing unit 42E executes operation (such as pair definition) of the substantial logical volume LDEV 00, LDEV 10 associated with the pseudo-logical volume LDEV 20 according to the operation content in the data area 7B.

With this arrangement, the management application 3A can issue a command by having it flexibly adjusted to either whether the in-band method or the out-of-band method, utilizing the command format.

Also, the management application 3A for the disk array system 1 issues a special command by attaching a header, which is necessary for the communication on the out-of-band method, and sends the special command to the UDP control unit 42D for the disk controller 42 via the communication on the out-of-band method.

Also, the management application 3A for the disk array system 1 may be provided in the host server 3 or in the management apparatus 9 connected to the service processor 43 from outside of the disk controller 42.

Also, the service processor 43 for the disk array system 1 has the definition file 6 that defines positional information about the logical volume LDEV 20 etc., which are accessed by the management application 3A. This definition file 6 includes, for each logical unit number, positional information about the substantial logical volume LDEV 00, LDEV 10 corresponding to the logical unit number and positional information (IP address) about the pseudo-logical volume LDEV 20.

With this arrangement, the management application 3A can determine a logical volume to be accessed according to the settings of the definition file 6. Specifically, if the definition file 6 defines the positional information about logical volumes to be accessed according to priority, each logical volume will be accessed in accordance with the priority.

(6) User Authentication Function (Second Embodiment)

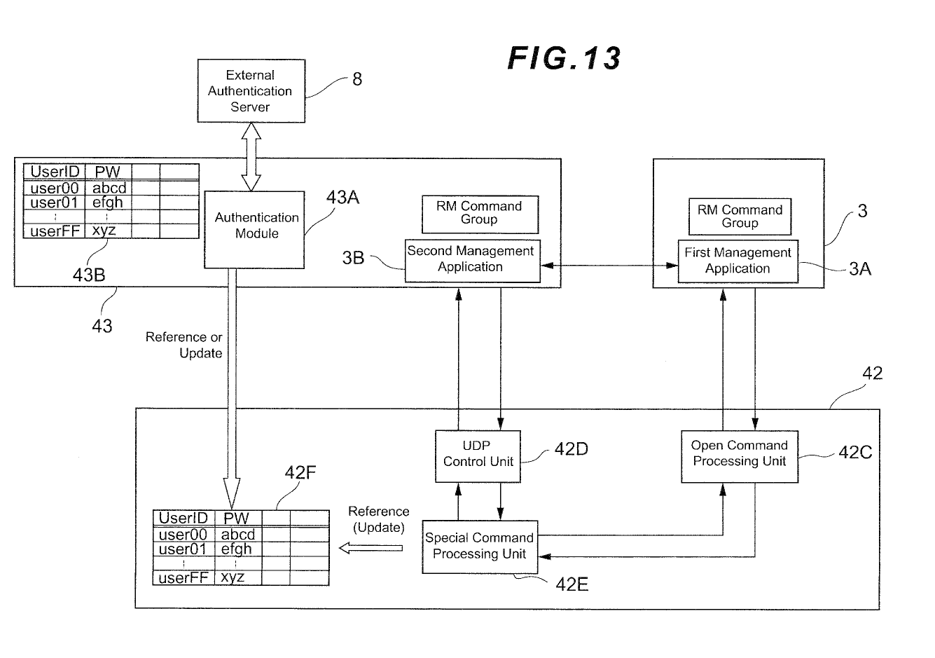

FIG. 13 shows an example of the configuration of a disk array system 1A according to the second embodiment. Since the configuration of the disk array system 1A according to the second embodiment is almost the same as that of the first embodiment and its variation, the same reference numerals used in the first embodiment and its variation are given to the same elements in the second embodiment as those in the first embodiment and its variation and an explanation thereof has been omitted, and differences between them will be mainly explained below. The disk array system 1A executes user authentication processing described later. The disk controller 42 has a session control table 42F in its built-in memory (not shown in the drawing). The session control table 42F manages user IDs and passwords. The user ID is an identifier corresponding to the first management application 3A. The password is user information used when the first management application 3A accesses the disk controller 42.

The service processor 43 has an authentication module 43A and a session control table 43B in, for example, its built-in memory (not shown in the drawing). The authentication module 43A is a microprogram for performing user authentication using the session control table 43B. The authentication module 43A has a function referring to and updating session control information in the session control table 42F for the disk controller 42. This authentication module 43A manages user IDs and passwords in the session control table 43B for the service processor 43.

During the mentioned special command processing, the special command processing unit 42E refers to or updates the session control information in the session control table 42F in order to authenticate whether or not a user who has made access is authorized to do so. This session control table 42F stores the content similar to the session control information in the session control table 43B for the service processor 43.

On a side note, the disk array system 1A may include an external authentication server 8. This external authentication server 8 has a function performing the user authentication together with or instead of the authentication module 43A and outside the disk array system 1A. The external authentication server 8 is connected to the service processor 43. The authentication module 43A provided in this service processor 43 performs the user authentication in accordance with user settings, using the session control table 43B and in cooperation with the external authentication server 8.

The disk controller 42 has the session control table 42F for controlling sessions between the disk controller 42 and the service processor 43. The session control table 42F manages, for example, user names, passwords, host names, status, effective periods, an access right, and authentication subject information as examples of session control information. This authentication subject information is setting information about whether the user authentication processing should be executed by the authentication module 43A for the service processor 43 or externally (corresponding to the external authentication server 8 described later).

The configuration used for the user authentication has been described above. Next, a user authentication method will be explained. The first management application 3A first issues a user authentication command for performing the user authentication to the special command processing unit 42E and sends it to the second management application 43A on the out-of-band method. The second management application 43A puts the received user authentication command in a packet and sends the packet to the UDP control unit 42D for the disk controller 42 on the out-of-band method. The UDP control unit 42D fetches the user authentication command from the packet and delivers it to the special command processing unit 42E.

The special command processing unit 42E executes the user authentication processing based on this user authentication command. During this user authentication processing, the special command processing unit 42E first refers to the session control information in the session control table 42F, using the user ID of the user, who has made access, as a search key. The special command processing unit 42E manages the status indicating the state of, for example, authentication at each user ID using a flag. If the user ID to be authenticated is not included in the session control information in the session control table 42F, the special command processing unit 42E first updates the status of that user ID in the session control table 42F during the authentication.

The authentication module 43A for the service processor 43 periodically refers to the session control table 42F for the disk controller 42 and checks if a user ID whose status is being authenticated exists or not. If such a user ID which is being authenticated exists, the authentication module 43A executes the user authentication processing and reflects the result in, for example, the status in the session control table 42F.

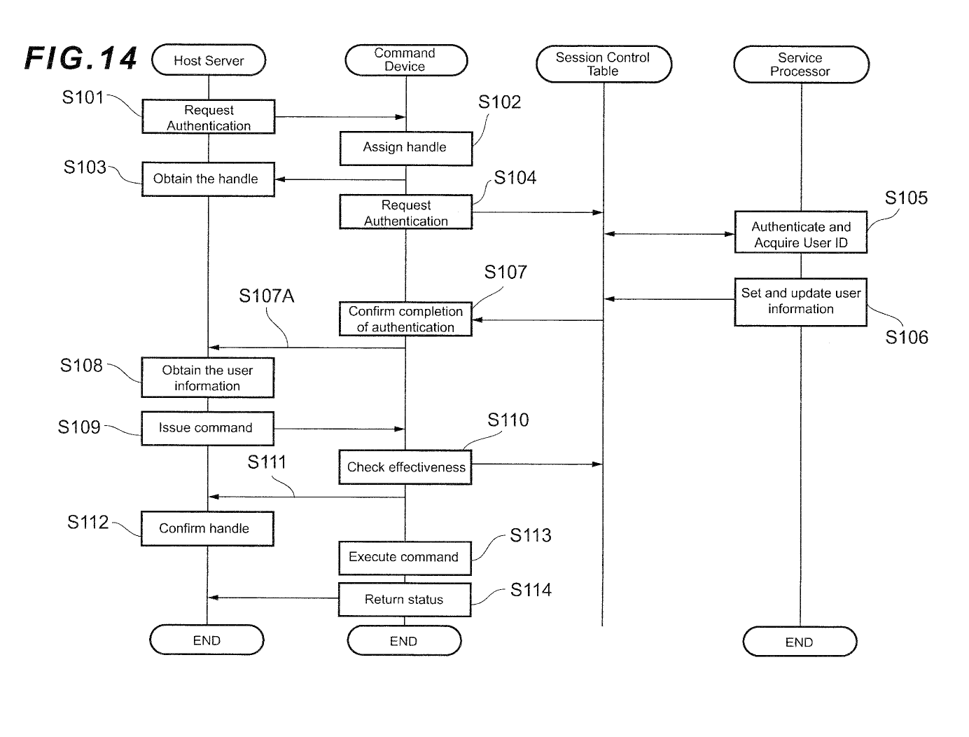

FIG. 14 shows an example of a processing sequence for the user authentication processing. Processing steps arranged in the left-sided vertical line in FIG. 14 indicate processing executed by the first management application 3A for the host server 3, processing steps arranged in the center vertical line indicate processing executed by the command device (corresponding to the special command processing unit 42E) for the disk controller 42, and processing steps arranged in the right-sided vertical line indicate processing executed by the service processor 43. On a side note, the status of the session control table 42F is shown between the disk controller 42 and the service processor 43.

Firstly, the host server 3 issues a user authentication command to the command device for the disk controller 42 in order to make a first authentication request (step S101). The command device assigns a handle to the authentication request (step S102). The host server 3 obtains the handle (step S103). On the other hand, with the command device, the special command processing unit 42E makes an authentication request (step S104). As a result, the session control table 42F is updated while its status is being authenticated.

If the service processor 43 (or its authentication module 43A) authenticates the user or if the user does not exist in the session control table 43B, the service processor 43 obtains a new user ID (step S105). Depending on the user settings, the service processor 43 (or its authentication module 43A) has the external authentication server 8 that executes the user authentication processing. The service processor 43 sets or updates the session control information (step S106). The command device checks if the authentication has been completed (step S107), obtains the session control information, and delivers it to the host server 3 (steps S107A, S108).

Next, the host server 3 issues a command to the command device (step S109). The command device checks if the user ID corresponding to the host server 3 is effective (that is, if it has the access right) or not (step S110); and the command device returns the check result to the host server 3. The host server 3 checks the handle (step S112). The command device executes the command (step S113) and returns the status of the execution result to the host server 3.

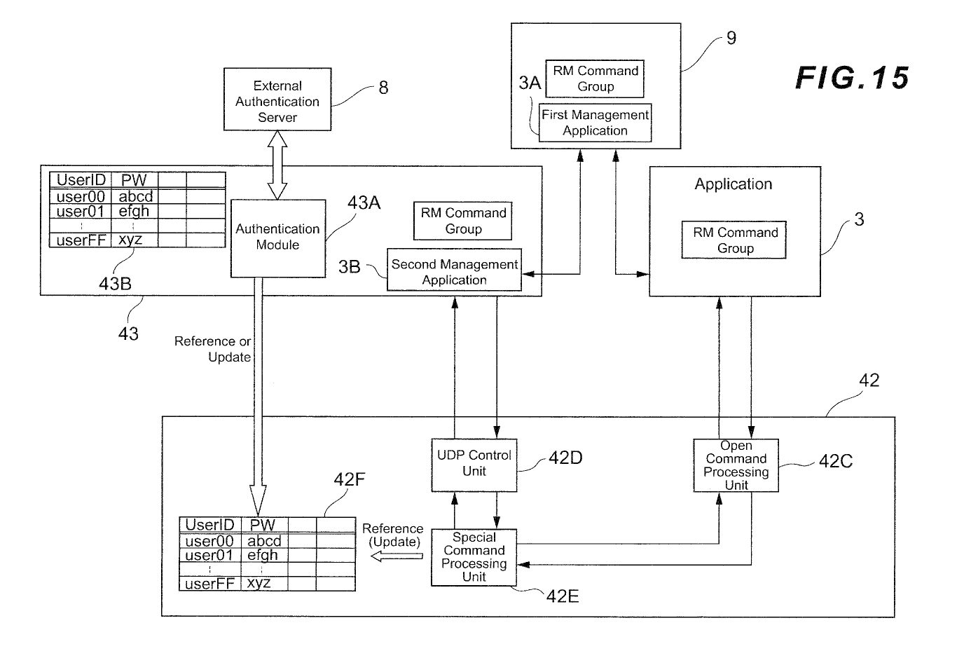

FIG. 15 shows a variation of the disk array system 1A according to the second embodiment. In this variation, the first management application 3A is provided in the management apparatus 9 instead of in the host server 3. Other elements of the configuration of the variation correspond to those shown in FIG. 12. In the configuration of such variation, the first management application 3A also issues the user authentication command in the same manner and has the authentication module 43A execute the user authentication processing as described above via the second management application 3B.

(7) Effects of the Second Embodiment

As explained above, the disk array system 1A according to the second embodiment has the session control table 42F for managing the access right to the disk controller 42 from outside as described above. If a command means the special command and a access request to the disk controller 42 is made from outside, the special command processing unit 42E judges based on the session control table 42F whether or not the access entity which made the access request has an access right.

It is favorable to use the above-described configuration in terms of security in a point that the user authentication can certainly been performed even when the out-of-band method, which is usually used in the state where the user authentication has not been performed, in comparison with the in-band method which is used in a state where the user authentication has been performed at the time of login to the host server 3.

With the disk array system 1A, the service processor 43 comprises the authentication module 43A. If an access request to the disk controller 42 is made from outside, this authentication module 43A judges whether or not the access entity has an access right based on the session control table 42F. If the command means a special command, the authentication module 43A judges whether the access entity has the access right or not.

With this arrangement, because the special command processing unit 42E itself does not have to perform the entire user authentication processing, it is possible to reduce processing load imposed by the special command processing unit 42E.

(8) Other Embodiments

The above-described embodiments are examples given for the purpose of describing this invention, and it is not intended to limit the present invention only to these embodiments. Accordingly, this invention can be utilized in various ways unless the utilizations depart from the gist of the present invention. For example, processing sequences of various programs have been explained sequentially in the embodiments described above; however, the order of the processing sequences is not particularly limited to that described above. Therefore, unless any conflicting processing result is obtained, the order of processing may be changed or concurrent operations may be performed.

1. A disk array system comprising:
a host system; and
a disk array apparatus for providing the host system with a substantial logical volume for reading and writing data;
wherein the disk array apparatus includes:
a disk controller for communicating data with the host system on an in-band method; and
a service processor for managing the configuration of the disk controller based on a command issued by a management application and received via communication on an out-of-band method;
wherein the disk controller includes:
a pseudo-logical volume provided independently from the substantial logical volume;
a command analyzer for analyzing the command received via communication on the in-band method or the out-of-band method; and
a special command processing unit for executing operation over the substantial logical volume which corresponds to the pseudo-logical volume, instead of executing operation over the pseudo-logical volume, if the command means an instruction to operate the pseudo-logical volume.

2. The disk array system according to claim 1, wherein the command analyzer includes:
a first command analysis processing unit for analyzing the command received via communication on the in-band method; and
a second command analysis processing unit for analyzing the command received via communication on the out-of-band method.

3. The disk array system according to claim 1, wherein a special command, as the instruction to operate the pseudo-logical volume, includes:
a header area containing a logical unit number, which indicates the pseudo-logical volume, and a specific command type; and
a data area containing a operation content for the substantial logical volume;
and wherein if the logical unit number indicates the pseudo-logical volume and the header area contains the specific command type, the special command processing unit executes operation over the substantial logical volume corresponding to the pseudo-logical volume in accordance with the operation content in the data area.

4. The disk array system according to claim 3, wherein the management application issues a special command by attaching a header necessary for the communication on the out-of-band method, and sends the special command to the second command analysis processing unit for the disk controller via the communication on the out-of-band method.

5. The disk array system according to claim 1, wherein the management application is provided in the host system.

6. The disk array system according to claim 1, wherein the management application is provided in a management apparatus connected to the service processor from outside of the disk controller.

7. The disk array system according to claim 1, wherein the service processor comprises a definition file that defines positional information about the logical volumes which are accessed by the management application; and
the definition file defines positional information about the substantial logical volume and positional information about the pseudo-logical volume.

8. The disk array system according to claim 1, wherein the disk array system comprises a session control table for managing access right to the disk controller from outside; and
wherein if the command is the special command and an access request is made to the disk controller from outside, the special command processing unit judges whether or not an access entity, which has made the access request, has the access right based on the session control table.

9. The disk array system according to claim 8, wherein the service processor has an authentication module for judging based on the session control table whether or not the access entity has the access right when the access request is made to the disk controller from outside; and
if the command is the special command, the authentication module judges whether or not the access entity has the access right.

10. A command processing method for a disk array system comprising:
a host system; and
a disk array apparatus for providing the host system with a substantial logical volume for reading and writing data;
wherein the disk array apparatus includes:
a disk controller for communicating data with the host system on an in-band method; and
a service processor for managing the configuration of the disk controller based on a command issued by a management application and received via communication on an out-of-band method; and
wherein the command processing method comprising:
a command analysis step for analyzing a command received via communication on the in-band method or the out-of-band method, executed by a command analyzer of the disk controller; and
a special command processing step for executing operation over the substantial logical volume which corresponds to the pseudo-logical volume, instead of executing operation over the pseudo-logical volume, executed by a special command processing unit of the disk controller, if the command is analyzed to be an instruction to operate the pseudo-logical volume in the command analysis step.
